(19) United States
(12) Patent Application Publication
(10) Pub. No.: US 2012/0041771 A1
(43) Pub. Date: Feb. 16, 2012

(54) SYSTEMS, METHODS, AND COMPUTER PROGRAM PRODUCTS FOR PATIENT MONITORING

(76) Inventors: Daniel L. Cosentino, Chaska, MN (US); Christopher T. Abrahamson, Bloomington, MN (US); Kristin N. Parrott, Jordan, MN (US)

(21) Appl. No.: 12/854,452

(22) Filed: Aug. 11, 2010

(51) Int. Cl. G06Q 50/00

(52) U.S. Cl. 705/2

(57) ABSTRACT

Software, or a pathway assistant, can be utilized to facilitate assessment or treatment recommendations of a remotely monitored patient and can run in the background. The pathway assistant, which searches data for key information and creates pathways, provides an automated system that standardized the assessment, treatment, management and evaluation of patients being monitored. The pathways generated allow a user, nurse, or caregiver, to follow precise instructions and assessing a patient's condition. The pathways software limits human error associated with assessment and provide more cost-effective management for large patient populations thus providing an advantage over prior art.

### TECHNICAL FIELD

The present disclosure is directed, generally, to wellness monitoring devices and, more specifically, to measuring devices that monitor patients with a disease or condition.

### BACKGROUND

There are a number of diseases and health-related conditions that are known to be associated with certain physiological parameters, including weight change due to fluid gain or loss. Non-limiting examples of diseases and conditions associated with fluid retention and associated weight change include kidney disease, congestive heart failure (CHF), cirrhosis of the liver, lymphatic obstruction, lymphedema, certain medications, and pre-eclampsia.

Chronic Kidney Disease (CKD), also known as chronic renal failure, includes a progressive loss of renal function over a period of months or years. CKD includes all individuals with kidney damage, as well as all individuals with a glomerular filtration rate (GFR) of less than 60 mL/min/1.73 m² for 3 months, irrespective of the presence or absence of kidney damage.

CKD is often divided into a series of five stages. Stage-five CKD, often referred to as End Stage Renal Disease (ESRD), includes patients with established kidney failure such as those with a GFR<15 mL/min/1.73 m², or those patients who require permanent renal replacement therapy. ESRD patients are usually treated by drugs, dialysis, and/or kidney transplant. Type 2 diabetes mellitus is the most common cause of ESRD in the U.S. Diabetic nephropathy is believed responsible for at least 25% of all renal dialysis patients. Other common causes of ESRD include hypertension and glomerulonephritis.

ESRD symptoms include weight change, such as weight gain due to fluid retention in the patient's tissues or weight loss. A measure of the patient's weight change is often used as an indicator of the patient's condition, where a weight above a threshold or below a threshold may require medical intervention, such as dialysis or drug therapy. Consistent monitoring of a patient's weight and application of appropriate treatment can minimize a patient's decline, reduce risk of re-hospitalization, and/or improve quality of life.

Conventional systems exist to monitor a patient from his or her home without the need for an in-home healthcare provider. However, such systems are unable to facilitate diagnosis and treatment. Therefore, improvements are desirable.

### BRIEF SUMMARY

According to an example embodiment, a method performed by a computerized weight measurement device comprises receiving data indicative of a weight. The weight is compared to a first weight parameter and a second weight parameter, generating information relevant to End Stage Renal Disease (ESRD) from comparing the weight to at least one of the first and second parameters. Output is then provided that includes the generated information.

Software, or a pathway assistant, can be utilized to facilitate assessment and treatment recommendations of a remotely monitored patient and can run in the background. The pathway assistant, which searches data for key information and creates pathways or roadmaps, provides an automated system for standardized assessment, treatment, and evaluation of patients being monitored. The pathways generated allow a user, nurse, or caregiver, to follow precise instructions for assessing a patient's condition. The pathways software limits human error associated with assessment thus providing an advantage over prior art. The pathways software also facilitates highly scalable, cost effective monitoring. Using the pathways software 1 Nurse can manage hundreds or even thousands of patients. Typically, staffing ratios can be increased from 1 Nurse:75 patients to 1 Nurse:500+ patients.

A second embodiment is a system which comprises a scale measuring a weight of a patient. The scale includes a processor-based device with a memory which stores a first weight parameter and a second weight parameter relevant to ESRD. The processor-based device compares the weight of the patient to the first and second weight parameters and provides patient feedback based on the comparison.

Another embodiment consists of a computer program product having a computer readable medium having computer program logic recorded thereon for monitoring a patient. The computer program product comprises code for facilitating assessment and treatment, including critical pathways.

Yet another embodiment is a system for monitoring ESRD that comprises means for measuring a weight of a patient, means for comparing the weight of the patient to a plurality of weight parameters relevant to ESRD, and means for providing output consistent with the comparing the weight of the patient to the plurality of parameters.

In another example embodiment, a method includes receiving data indicative of a physiological parameter; scanning the data; determining if any of the data matches pre-defined criteria, and if any of the data matches pre-defined criteria, then generating a medical pathway for assessment by a user; and providing output including the medial pathway; wherein the user can follow the medical pathway to assess, educate, intervene, or provide treatment recommendations to the patient; or notify a remote health care provider of the patient status.

In another example embodiment, a system for assessment of remotely monitored patients includes a receive module for receiving data from remote monitoring devices; a pathways module for generating medical pathways based on the data received; and a management module for managing a plurality of medical pathways.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is an illustration of an exemplary system for monitoring patient wellness, adapted according to one example embodiment;

FIG. 2 is an illustration of an exemplary operational flow performed by a monitoring device according to one example embodiment;

FIG. 3 is a block diagram of an exemplary monitoring device adapted according to one example embodiment;

FIG. 4 is an illustration of an exemplary integrated monitoring device, such as may include the features shown in FIG. 3 to provide patient monitoring, according to one example embodiment;

FIG. 5 is an illustration of an exemplary integrated monitoring device, such as may include the features shown in FIG. 3 to provide patient monitoring, according to one example embodiment;

FIG. 6 is operational flow diagram of a pathways software, according to an example embodiment;

FIG. 7 is an example screen shot of a global queue, according to an example embodiment;

FIG. 8 is an example screen shot of a member queue, according to an example embodiment;

FIG. 9 is an example screen shot of a open pathways screen, according to an example embodiment;

FIG. 10 is an example screen shot of an assessment category, according to an example embodiment;

FIG. 11 is an example screen shot of a guide me screen, according to an example embodiment;

FIG. 12 is an example screen shot of a notes field, according to an example embodiment;

FIG. 13 is an example screen shot of a summary field, according to an example embodiment;

FIG. 14 is an example screen shot of a triggered rules field, according to an example embodiment; and

FIG. 15 is an example screen shot of a closed pathway field, according to an example embodiment.

FIG. 16 is an example screen shot of a pathway summary, according to an example embodiment.

### DETAILED DESCRIPTION

In general software, or a pathway assistant, can be utilized to facilitate assessment or treatment recommendations of a remotely monitored patient and can run in the background. The pathway assistant, which searches data for key information and creates pathways, provides an automated system that standardized the assessment, treatment, and evaluation of patients being monitored. The pathways generated allow a user, nurse, or caregiver, to follow precise instructions and assessing a patient's condition. The pathways software limits human error associated with assessment and significantly increase efficiencies for managing large dialysis patient populations (hundreds of thousands of dialysis patients) thus providing an advantage over prior art.

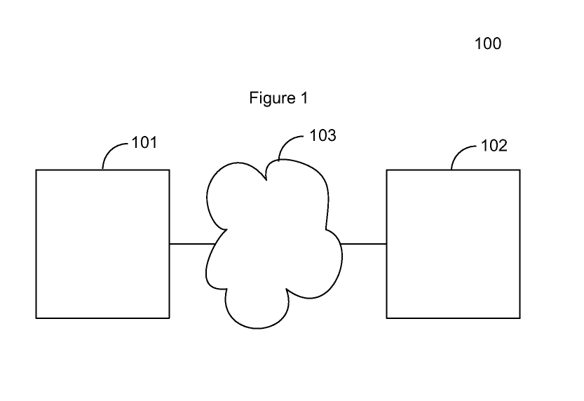

FIG. 1 is an illustration of the exemplary system 100 for monitoring patient wellness, adapted according to one embodiment. Physiological data of a patient is monitored utilizing a monitoring apparatus 101 and output is provided to the patient, caregiver, a remote computer 102, and/or a health care provider. Data generated from the monitoring is transmitted to the remote computer 102 via a communication network 103. In one embodiment, patient data contemplated for transmission includes a patient's weight but might include any physiological parameter answers to questions, or other data. Patient data may also include other data from the monitoring, such as blood pressure, electrocardiogram, fluid intake, fluid output, bio impedance, blood glucose, symptoms related to ESRD, and the like. The remote computer 102 may be, for example, at a facility for a health care provider, a dialysis treatment center, where a nurse, physician or nurse practitioner monitors the patient data and provokes treatment in accordance with such data. Similarly, in various embodiments, the monitoring apparatus 101 is located at a healthcare facility, a dialysis treatment center, a patient's residence, or other location convenient to the patient. Additionally, in some embodiments, the monitoring apparatus 101 includes processes that present messages to a patient informing the patient of the results of the monitoring, inviting the patient to contact a health care professional, accelerate their dialysis treatment schedule, or instructing the patient to modify drug, diet or care plan, ask the patient certain questions, and the like.

In the examples below, the monitoring apparatus includes a weighing device, such as a scale that has a processor and memory operably configured to compare the patient's weight with various parameters relevant to ESRD, or other conditions, and to perform one or more processes to facilitate the patient's treatment. Operation of the monitoring apparatus 101 and communication therewith are described in more detail below.

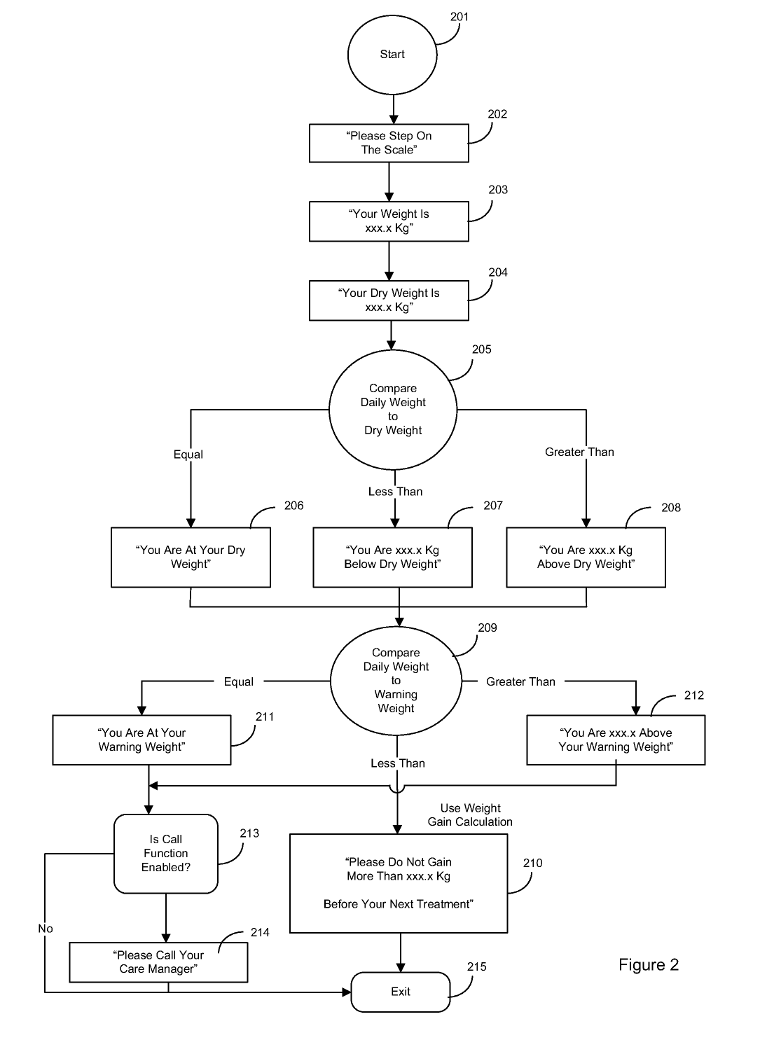

FIG. 2 is an illustration of an exemplary operational flow diagram 200 performed by a monitoring device according to one example embodiment. For instance, the monitoring device 101 (FIG. 1) can be adapted to perform the operational flow 200.

The operational flow 200 begins at 201. At block 202, the monitoring device presents a message (e.g., on a computer screen or other type of screen) imploring the user to step on the scale. When the user ascends the scale, the monitoring device, using one or more transducers, measures the weight of the patient. At block 203, the monitoring device presents a message in response to the patient's stepping on the scale, where the message gives the patient's weight (also referred to below as “daily weight”). The monitoring device may also calculate and/or store the patient's dry weight with a date and time. In the examples below, the dry weight is one parameter used to assess the condition or fluid status of the patient. The dry weight may be set, remotely or otherwise, by a health care provider familiar with the patient's condition. At block 204, a message is presented giving the patient's dry weight.

The monitoring device compares the patient's weight to the patient's dry weight at block 205. If the patient's weight is substantially equal to the patient's dry weight, the monitoring device presents a message to the patient to that effect at block 206. If the patient's weight differs from the patient's dry weight, the patient receives a message informing the patient of the difference at one of blocks 207 and 208.

Alternatively after block 203 the process can start at block 209, whereby the patient's weight is compared to the patient's warning weight to derive information about the patient's condition. The warning weight, in this example, includes a high weight limit of the patient and may be calculated by the monitoring device or set, remotely or otherwise, by a health care provider. In one example, the warning weight is a number equal to a mean pre-dialysis weight plus a constant, as shown in Equation (1).

Warning Weight=(mean pre dialysis weight over past 30 days)+1 Kg (1)

Should the patient's weight be below the patient's warning weight, such condition is usually a good indication for the patient. Accordingly, the patient is shown a message informing the patient to continue to control his or her weight, but no alarm or exception is issued for the warning weight parameter. In one embodiment, the monitoring device uses a weight gain calculation, such as that shown in Equation (2) in order to formulate the message of block 210. The operational flow 200 then exits at block 215.

Weight Gain=(Warning Weight−1 Kg)−Daily Weight (2)

On the other hand, should the patient's weight be at or above the warning weight, the patient is informed of such condition. Specifically, if the patient's weight is at the warning weight, a message to that effect is presented to the patient at block 211. Similarly, if the patient's weight is above the warning weight, a message to that effect is presented to the patient at block 212.

If the patient is at or above his or her warning weight, the operational flow 200 advances to block 213 where it is discerned whether the monitoring device has an enabled call function. If the call function is not enabled, then the operational flow 200 exits at block 215. If the call function is enabled, then the patient is presented a message at block 214 to call his or her health care provider. In some embodiments, the message is interactive (e.g., using a touchscreen or keypad), allowing the patient to establish the call. In other embodiments, the call may be placed automatically. In other embodiments, the patient could be provided with specific dialysis care plan or treatment instructions. In addition, questions may be asked of the patient to aid in diagnosing the patient's condition. The operational flow exits at block 215.

The operational flow 200 is especially useful in monitoring ESRD patients. For instance, comparing a patient's weight to the dry weight and/or the warning weight provides some reference as to the patient's interdialytic weight gain (IDWG). This is important as excessive interdialytic weight gain (IDWG) is usually related to an overload of sodium and water, and is an important factor for arterial hypertension in dialysis, which may accelerate left ventricular remodeling and increase risk for cardiovascular events and death.

Various embodiments may use other parameters in addition to, or alternatively to, a dry weight and a warning weight, e.g., a lower weight limit for a patient equal shown in Equation (3). Furthermore, various embodiments may modify one or more of dry weight and warning weight from the descriptions given above or monitor other physiological parameters.

Minimum Weight=(mean post dialysis weight in past 30 days)−1 Kg (3)

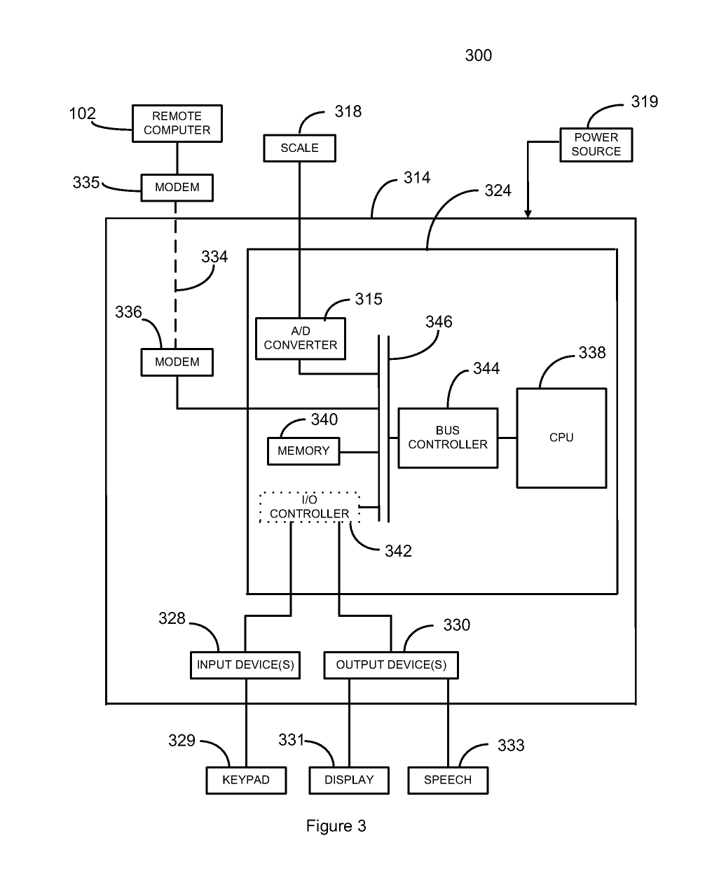

Communication is established with the remote device 102 (FIG. 1) to transmit data consistent with the comparison at block 209 and/or at block 205 and/or any other information relevant to the patient's wellness, i.e. answers to questions asked. Once communication is established with the remote device, the information is transferred and analysis of the data can be performed. In addition, a health care provider can provide treatment to the patient by, e.g., initiating automatic processes in the monitoring device (e.g., taking blood pressure or presenting a questionnaire), scheduling a nurse or doctor visit, and the like. The content and timing of the communication is discussed in more detail with respect to FIG. 3 below.

FIG. 2 shows various messages presented to a user, and some of the messages can be interactive. Other embodiments may present messages using a different medium (e.g., audio and/or video), a different format (e.g., using different measuring units or languages) or, even, different substance. Any message that may be useful to present to a patient may be presented in various embodiments. For instance, Table 1 provides a non-exclusive list of message alternatives that may be adapted for use in the operational flow 200. The messages can be used to gain information from the patient regarding the patient's symptoms and status. Answers to the questions can then be transmitted to the remote device 102 (FIG. 1).

TABLE 1

| Category | Message |
|---|---|
| Provider | Do you want your nurse to call you? |
| | Do you need a call from your nurse? |
| Device Scripts | Please call your Care Manager |
| | Please call your Nephrologist |
| | Please call your Kidney Doctor |
| | Please call your Dialysis Unit |
| | Please call your Doctor |
| | For emergencies call your doctor or 911 |
| Weight Comparison | Your Dry Weight is |
| | You are at your Dry Weight |
| | You are at your Weight Limit |
| | You are at your Low Warning Weight |
| | You are at your Minimum Weight |
| | You are at your Warning Weight |
| | You are |
| | Below Dry Weight |
| | Above Dry Weight |
| | Above your Weight Limit |
| | Below your Weight Limit |
| | Above your Warning Weight |
| | Below your Warning Weight |
| | Above your Minimum Weight |
| | Below your Minimum Weight |
| | Above your Low Warning Weight |
| | Below your Low Warning Weight |
| Gain | You should not gain more than |
| | Try not to gain more than |
| | Please do not gain more than |
| | Before your next treatment |

Additionally, in some embodiments, the monitoring device may present one or more interactive messages in Table 2 as a standard question set, where questions answered positively generate an exception (reported to the remote device 102) regardless of a symptom score that may be assigned and where scores can be changed at a later date. In fact, the scope of embodiments is not limited to the monitoring of ESRD, as functionality to monitor other diseases may be additionally included in some embodiments. In one example, a Telescale® monitoring device, available from Cardiocom, LLC, which is operable to monitor symptoms of diseases such as congestive heart failure, is modified to additionally include functionality to perform the operational flow 200 of FIG. 2 and to include some or all content of Tables 1 and 2. A Telescale® monitoring device is described in U.S. Pat. No. 6,290,646, which is incorporated herein by reference in its entirety. An important aspect of the invention is a library of interactive messages and education statements for ESRD patients that are focused on a broad range of topics including, but not limited to: access management, fistula and graft options, infection and wound identification and management, adherence with dialysis treatment schedules, compliance with fluid intake restrictions, general dialysis treatment options (home hemodialysis, peritoneal dialysis), and transplant options. Such interactive messages may be included in the question set of one embodiment, where the interactive messages also include the co-morbidities of ESRD such as CHF, hypertension and diabetes, which are important in the integrated care for dialysis patients.

TABLE 2

| # | Symptom | Abbreviated Sample Question List | Score |
|---|---|---|---|
| 1 | SOB | Are you feeling short of breath? (If yes, ask all 3 questions | 4 |
| | | below) | |
| | | More short of breath than normal? | 3 |
| | | Are you short of breath at rest? | 3 |
| | | Are you getting enough air? | 2 (Acute) |
| 2 | Fever | Do you feel feverish or have chills? (If yes, ask question | 3 |
| | | below) | |
| | | Is your temperature above 99 degrees? | 3 |
| 3 | Infection | Do you have a sore or an open wound? (If yes, ask all 3 | 2 |
| | | questions below) | |
| | | Is it new? | 2 |
| | | Is it red or draining? | 3 |
| | | Is it healing? | 1 |
| 4 | General Health | Do you have any new health concerns? | 2 |
| 5 | Access | Are you having any problems with your dialysis access? | 3 |
| | | Are you having any redness, swelling or pain at your access | 4 |
| | | site? | |
| 6 | Provider | Would you like a call from your dialysis nurse? | 2 |
| | | For emergencies call your doctor or 911 | |
| 7 | Medications | Are you taking all your medication? (If no, ask both | 1 |
| | | questions below) | |
| | | Are you out of any medication? | 1 |
| | | Do you have any medication concerns? | 1 |

FIG. 3 is a block diagram of an exemplary monitoring device 300 adapted according to one embodiment and operable to perform the functions described above with respect to FIG. 2. A microprocessor system 324 including a CPU 338, a memory 340, an optional input/output (I/O) controller 342 and a bus controller 344 is illustrated. It will be appreciated that the microprocessor system 324 is available in a wide variety of configurations and is based on CPU chips such as a general purpose processor, an Application Specific Integrated Circuit (ASIC), a Digital Signal Processor (DSP), a multi-core chip package, and/or the like.

In this example, the memory 340 includes computer-executable code therein, which when executed, causes the CPU 338 to perform functions consistent with that shown in FIG. 2 and other functions described herein. When implemented via computer-executable instructions, various elements of embodiments are in essence the software or firmware code defining the operations of such various elements. The executable instructions may be obtained from the memory 340, which includes a tangible readable medium (e.g., a hard drive media, optical media, RAM, EPROM, EEPROM, tape media, cartridge media, flash memory, ROM, memory stick, and/or the like). In fact, readable media can include any medium that can store information.

The monitoring device 300 may be powered in any of a variety of ways, such as by ordinary household A/C line power, DC batteries, rechargeable batteries, and/or the like. Power source 319 provides electrical power for operating the electronic devices. A power source for operating the electronic scale 318 is generated within the housing, however those skilled in the art will recognize that a separate power supply may be provided or the power source 319 may be adapted to provide the proper voltage or current for operating the electronic scale 318.

The housing 314 includes a microprocessor system 324, an electronic receiver/transmitter communication device such as a modem 336, an input device 328 and an output device 330. The modem 336 is operatively coupled to the microprocessor system 324 via the electronic bus 346, and to the remote computer 102 via a communication network 334 and modem 335. The communication network 334 may be any communication network such as the telephone network, wide area network or Internet. It will be appreciated that the modem 336 may include a generally well known product commercially available in a variety of configurations operating at a variety of BAUD rates for dial-up or high-speed Internet access.

The output device(s) 330 are interfaced with the microprocessor system 324. These output devices 330 include a visual electronic display device 331 and/or a synthetic speech device 333. Electronic display devices 331 are well known in the art and are available in a variety of technologies such as vacuum fluorescent, liquid crystal or Light Emitting Diode (LED). The patient reads alphanumeric data as it scrolls on the electronic display device 331, which in some embodiments, may include a touch-screen device that interacts with the patient by sensing touch. Output devices 330 include a synthetic speech output device 333 such as a Chipcorder manufactured by ISD (part No. 4003), or direct wav. file or sound file playback by digital to analog converter, but may also include a speech-input and recognition device. Still, other output devices 330 include pacemaker data input devices, drug infusion pumps, home dialysis equipment or transformer coupled transmitters.

The messages shown in FIG. 2 and Tables 1-3 can be presented audibly or on a user interface presented on the display device 331. It will be appreciated that input device(s) 328 may be interfaced with the microprocessor system 324 and may be included additionally to, or alternatively to, a touchscreen. In one embodiment an electronic keypad 329 is provided for the patient to enter responses into the monitoring apparatus. Patient data entered through the electronic keypad 329 may be scrolled on the electronic display 331 or played back on the synthetic speech device 333. Patient input may also be audibly received through the speech device 333 in some configurations.

The microprocessor system 324 is operatively coupled to the modem 336, the input device(s) 328 and the output device(s) 330. The electronic scale 318 is operatively coupled to the central system 324. Electronic measurement signals from the electronic scale 318 are processed by the A/D converter 315. This digitized representation of the measured signal is then interfaced to the CPU 338 via the electronic bus 346 and the bus controller 344. In one embodiment of the invention, the physiological transducing device includes the electronic scale 318. The electronic scale 318 may include one or more of the following elements: load cells, pressure transducers, linear variable differential transformers (LVDTs), capacitance coupled sensors, strain gages and semiconductor strain gages. These devices convert the patient's weight into a useable electronic signal that is representative of the patient's weight. The electronic scale 318 is generally well known and commercially available, and any compatible electronic scale now known or later developed can be used in various embodiments.

Furthermore, an A/D converter 315 may be included within the scale 318 or within the microprocessor system 324 or within the housing 314. One skilled in the art has a variety of design choices in interfacing a transducing device comprising an electronic sensor or transducer with the microprocessor system 324.

The scale 318 may provide an analog or digital electronic signal output depending on the particular type chosen. If the electronic scale 318 provides an analog output signal in response to a weight input, the analog signal is converted to a digital signal via the A/D converter 315. The digital signal is then interfaced with the electronic bus 346 and the CPU 338. If the electronic scale 318 provides a digital output signal in response to a weight input, the digital signal may be interfaced with electronic bus 346 and the CPU 338. Furthermore, an internal A/D converter connected to a transducer, such as a pressure sensor, can be used to provide pressure information to the CPU for blood pressure measurement.

As will be appreciated by those skilled in the art, various embodiments may differ from the configuration shown in FIG. 3. For instance, the communication path including modems 335 and 336 may be supplemented by, or replaced by, a wireless communication path operable to communicate over one or more networks, such as an IEEE 802.11 network or a 3G or 4G cellular network. Furthermore, various embodiments may include more or fewer transducers or transducers of different types than that shown in FIG. 3 while still performing functions the same as, or similar to, that shown in FIG. 2.

During operation, the monitoring device 300 presents a message, such as that shown in block 202 of FIG. 2, inviting the patient to ascend the scale 318. The patient's weight is measured and compared to parameters by the CPU system 324. Additionally, one or more interactive messages may be presented to the user via the output devices 330, 331, 333 to inform the user of the user's weight status, blood pressure, and/or to inquire about other health factors. Examples of interactive messages to inquire about health factors are shown in Tables 1-2, above. The user interacts with the monitoring device 300 by using the keypad, the display 331 (in the case of a touchscreen), and/or the speech module 333 (if the speech module 333 includes input-receiving functionality) to answer the interactive messages.

Communication with the remote computer 102 (e.g., located at a health care provider facility) may be initiated by the monitoring device 300 automatically in some embodiments. In one example, when an exception is issued, such as by an answer to an interactive question or by a weight measurement at or above a warning weight, the monitoring device automatically alerts the remote computer 102 to the exception or may automatically alert a care giver. In another scenario, the patient's weight data, blood pressure or other vital signs, exceptions, and/or answers to interactive messages are automatically transmitted to the remote computer 102 as they are generated. Establishment of communication can be automatic, periodic, exception-driven, patient-initiated, remote computer 1020-initiated, and/or the like.

In one example, the patient's weight data, blood pressure, or other vital signs, exceptions, and/or answers to interactive messages are transmitted to the remote computer 102, where such information is further analyzed and/or processed. Upon uploading the information to the remote computer 102, a medical professional caregiver may telephone the patient to discuss, clarify or validate any particular wellness parameter or physiological data point. In addition, particular software is used to facilitate further assessment or treatment recommendations as will be explained in more detail below. The conversation may be carried out over a telephone network by a conventional telephone device (not shown) or over the computer network 103 (FIG. 1) using the speech device 333 and a computer network telephony technology, such as Voice Over IP (VOIP). Furthermore, the medical professional caregiver may update the list of wellness parameter questions listed in Tables 1-3 from the remote computer 102 over the two-way communication network 103 (FIG. 1). The modified query list is then stored in the memory 340 of the microprocessor system 324.

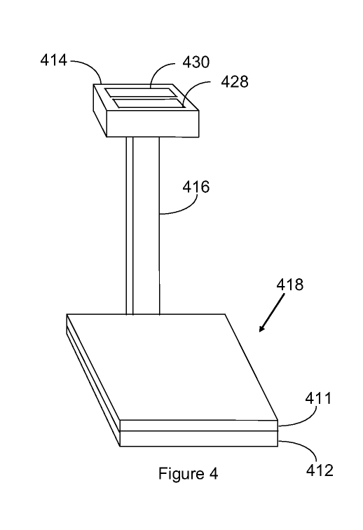

FIG. 4 is an illustration of an exemplary integrated monitoring device 400, such as may include the features shown in FIG. 3 to provide patient monitoring. The integrated monitoring device 400 includes an electronic scale 418. The electronic scale 418 further includes a top plate 411 and a base plate 412. The integrated monitoring device 400 further includes a housing 414 and a support member 416. The base plate 412 is connected to the housing 414 through the support member 416. The housing 414 further includes output device(s) 430 and input device(s) 428. The integrated monitoring device 400 is integrated as a single unit with the support member coupling the base plate 412 and the housing 414, thus providing a unit in a one piece construction. An example scale is described in U.S. Pat. No. 7,577,475, which is incorporated herein by reference in its entirety.

It will be appreciated that other physiological transducing devices can be utilized in addition to the electronic scale 418. For example, blood pressure measurement apparatus and electrocardiogram (EKG) measurement apparatus can be utilized with the integrated monitoring device 400 for recordation and/or transmission of blood pressure and EKG measurements to a remote location. It will be appreciated that other monitoring devices, such as blood glucose, oxygen saturation, bio impedance, and other physiological body functions that provide an analog or digital electronic output may be utilized with the integrated monitoring device 400. Furthermore, various embodiments may provide enhanced transportability and compactness by, for example, making one or parts foldable and/or making the support member 416 telescoping.

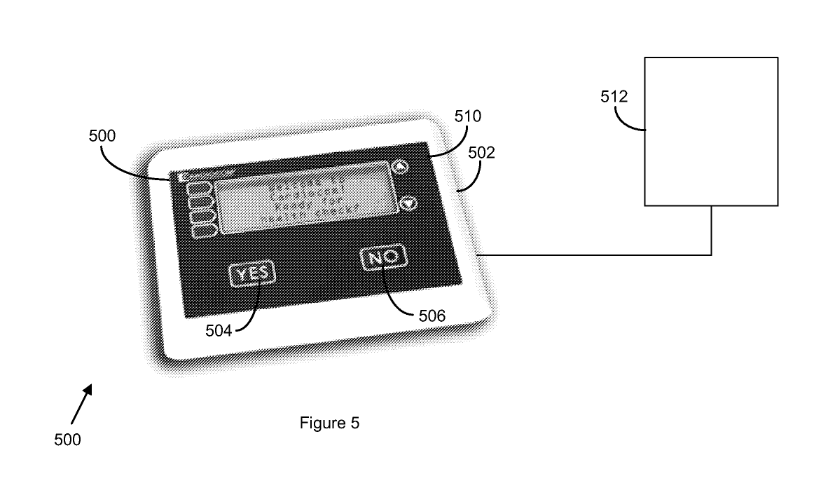

FIG. 5 is an illustration of an exemplary integrated monitoring device 500, such as may include the features shown in FIG. 3 to provide patient monitoring. The integrated monitoring device 500 includes a monitoring console 502. The console 502 preferably includes a “yes” button 504 and a “no” button 506 for interacting and answering questions posed to the patient. The console 502 preferably also includes scroll buttons 510 for scrolling and other buttons 508. Additional buttons may be included for multiple choice and survey questions. The console can be connected to a physiological measuring device 512. The physiological measuring device can be any device capable of measuring or monitoring a physiological parameter, such as a blood pressure monitor, a pulse oximeter, a scale, a glucose meter, a peak flow meter for measuring lung capacity, and the like.

While the embodiments of FIGS. 4 and 5 are shown as stand-alone units, the scope of embodiments is not so limited, as other embodiments may differ somewhat in configuration. In one example, the calculating and communication functionality is included in a general purpose computer that is in communication with one or more peripheral physiological transducing devices.

The following is an example list of terminology and/or equations that may be useful.

Terminology

| | |
|---|---|
| Daily Weight = | Weight recorded that day |
| Warning Weight = | High weight limit of the patient |
| Dry Weight = | Estimated Dry Weight of patient from dialysis |
| | facility order or from order of other health care |
| | provider |
| Minimum | Low weight limit of the patient |
| Weight (LCL) = | |
| Weight XY = | Max weight gain/day |
| Weight Gain = | Weight left until patient gets close to Warning |
| | Weight |
| Pre Dialysis | Patient weight before dialysis measured by dialysis |
| Weight = | unit |
| Post Dialysis | Patient weight after dialysis measure by dialysis unit |
| Weight = | |
| Interdialytic | difference between Pre Dialysis weight and last Post |
| Weight Gain = | Dialysis weight |

Equations

| | |
|---|---|
| Warning Weight = | (mean pre dialysis weight over past 30 days) + 1 Kg |
| Estimated Dry | Ordered by physician |
| Weight = | |
| Minimum Weight = | (mean post dialysis weight in past 30 days) − 1 Kg |
| Weight XY = | (Maximum interdialytic weight gain in past 30 |
| | days + 1 Kg)/3 |
| Weight Gain = | (Warning weight − 1 Kg) − daily weight |

In general, software, or a pathway assistant, can be utilized to facilitate diagnosis or treatment of a remotely monitored patient and can run in the background. The pathway assistant, which searches patient data for key information and creates pathways, provides an automated system that standardized the diagnosis, assessment, treatment, evaluation and management of patients being monitored. The pathways generated allow a user, nurse, or caregiver, to follow precise instructions for assessing a patient's condition. The pathways software limits human error associated with assessment and provides more efficient, large population management thus providing an advantage over prior art.

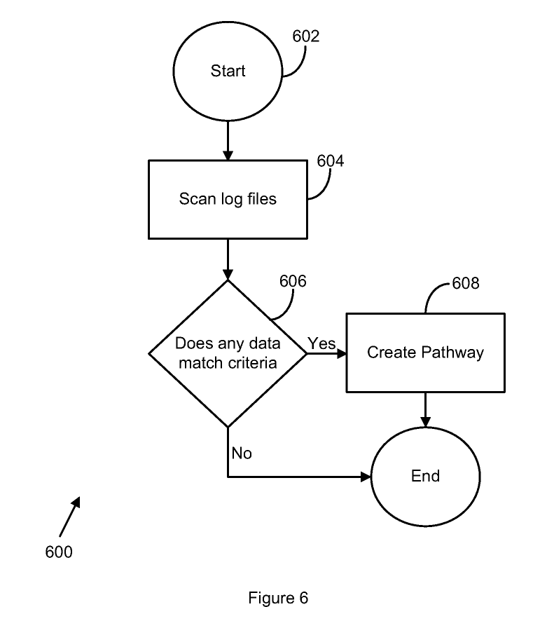

Referring to FIG. 6, a logic flow diagram is provided for creating a pathway 600, such as a pathway for diagnosing or treating a patient. Operational flow starts at block 602. A scan module 604 scans new log files received from, for example, a remote monitoring device or other remote data source (i.e. dialysis treatment center lab values,). A determine module 606 determines if any data in the new log files matches pre-defined data. If the determine module 606 determines that data does match pre-defined data, operational flow branches “YES” to a pathway module 608 that creates a pathway for assessment by a user, nurse, or care giver. Operational flow ends at block 610. Referring to the determine module 606, if the determine module 606 determines that no data matches, operational flow branches “NO” to the end block 610, and no corresponding pathway is created.

Preferably, the pathway assistant searches for key types of activities that include real time biometric/symptomatic alert pathways, upcoming scheduled pathway activities/events, or other data driven patient or population specific elements. When a specified criteria is met, a pathway is generated and assigned to the patient. For example, when a monitoring apparatus 101 connects with a remote computer 102 and transmits information the remote computer 201, a device log is created which describes the types of data that has been received, for example, weight, PEFR, SPO2, Glucose, Blood Pressure, Heart Rate, and Health Check responses. The pathway assistant scans this device log for pre-selected criteria, and when matches are found, the associated pathway is created and assigned to a patient.

The pathway generated by the assistant is different from standard alerts in that they allow for more granularity in the areas of recurrence and trending. The pathway itself creates a standardized methodology for dealing with episodes and out of scope symptoms, biometrics or lab values. In other words, the pathway provides a roadmap for a caregiver to follow to ensure that correct assessment and treatment recommendations are provided. The pathway is advantageous because it facilitates assessment and treatment of patients in a standardized methodology that limits human error.

The caregiver simply follows the roadmap and fills in the appropriate information and follows the appropriate instructions as provided by the pathway. The pathway assistant also creates pathways for upcoming scheduled events. These events are not alert events but normal regular follow-up or maintenance. This type of pathway is created in a “suspended” state, meaning that it is not active or in need of immediate attention. On the due date of the schedule, the pathway automatically moves to an active status to indicate it is in need of attention. An example of a scheduled event might include annual medication assessments, QOL surveys, or flu shot reminders. Once this pathway is closed the assistant will create a new one with the scheduled date set to the next predefined date interval (months, weeks, or days).

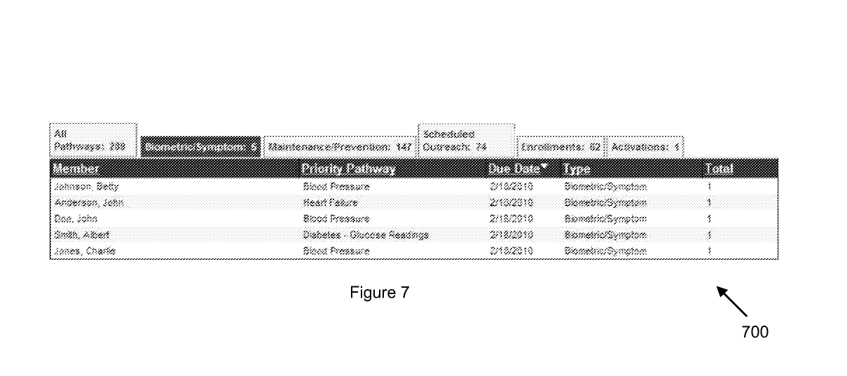

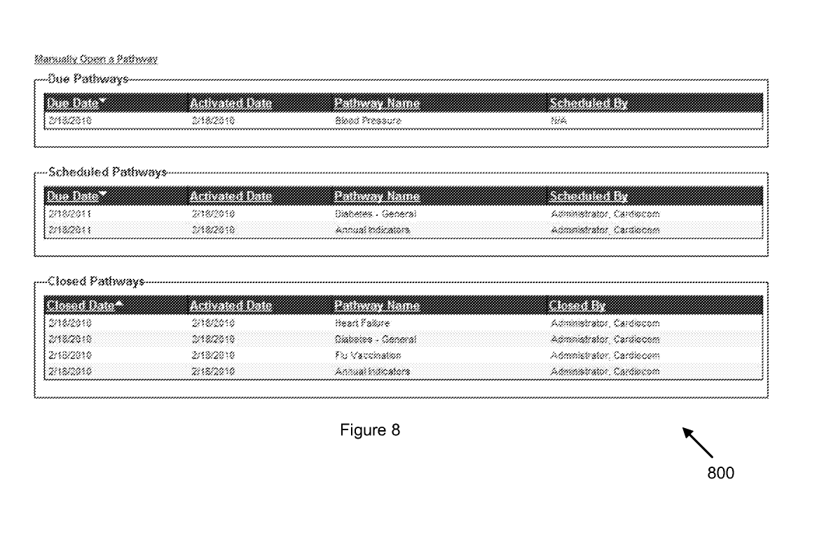

Pathways can be triggered by referencing multiple variables. Some of these variables include: vital signs or symptoms transmitted by a monitoring device; predefined schedules, manually by a user, lab values, or dialysis treatment values. The pathways can be organized for better handling. FIG. 7 is an example of a global pathways work queue 700. This global queue 700 lists all the current pathways. FIG. 8 is an example of a member pathways work queue 800. This member queue 800 lists all the current pathways for a particular member. From the global pathways work queue 700, a user can select a member to go to the member queue 800. From here, a user can choose to manually open a pathway, open a pathway that is “due”, open a “scheduled” pathway, or view closed pathways.

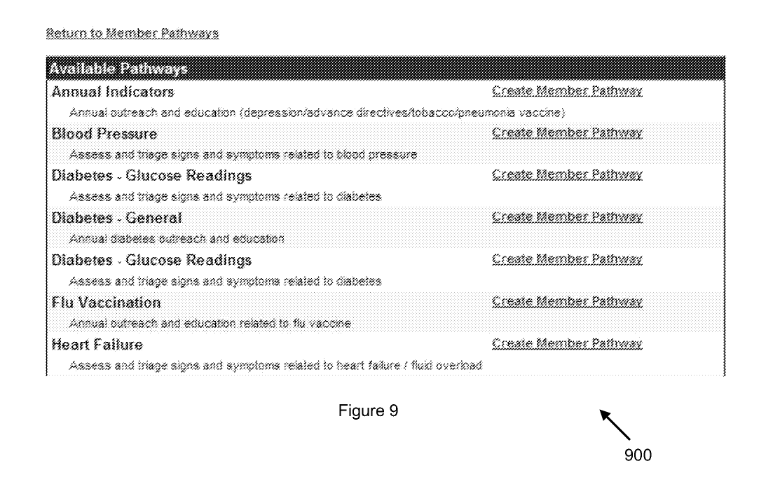

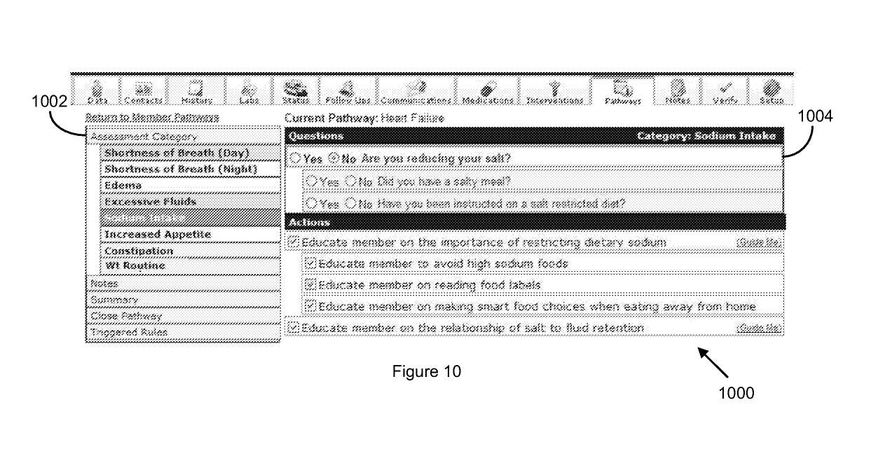

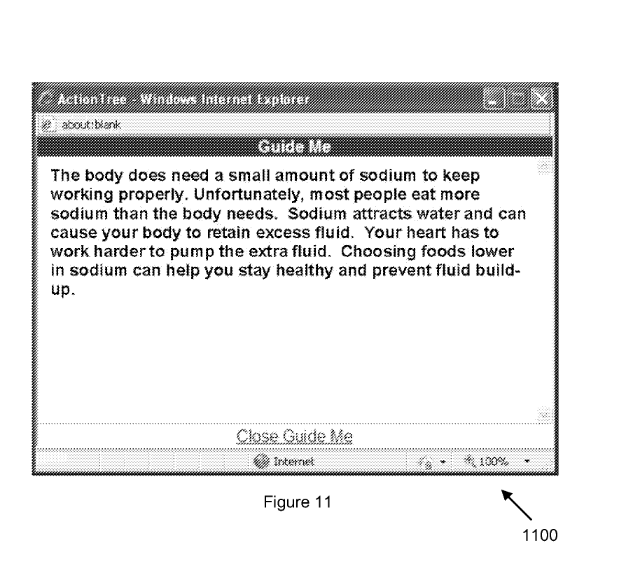

FIG. 9 is an example screen shot 900 for manually opening a pathway and provides a listing of available pathways. FIG. 10 is an example of a member pathway 1000. Each pathway 1000 has certain assessment categories 1002. In this example, the categories are color coded to facilitate use by a user. Red categories have an alert or positive response to a question. Green categories have a response that is normal or expected. Blue categories indicate a category that has not yet been addressed. Each category has certain “questions” 1004 to be asked and the answers recorded. It is noted that the pathway includes the possible answers. An example question to be asked is “did you have a salty meal?” and the available answers are yes or no. The user can populate the correct answer. Each question has the possibility to have corresponding actions, or secondary pathways, based on the answer. Questions and actions can have “guide me” links that open to provide detailed educational content 1100, as illustrated in FIG. 11. Question and action selection is point and click on the requested boxes or radio buttons. Questions and actions have branching logic built-in. For example, if you select “YES” to a certain question, the pathway may automatically populate with additional questions. Actions can be programmed to be optional or required.

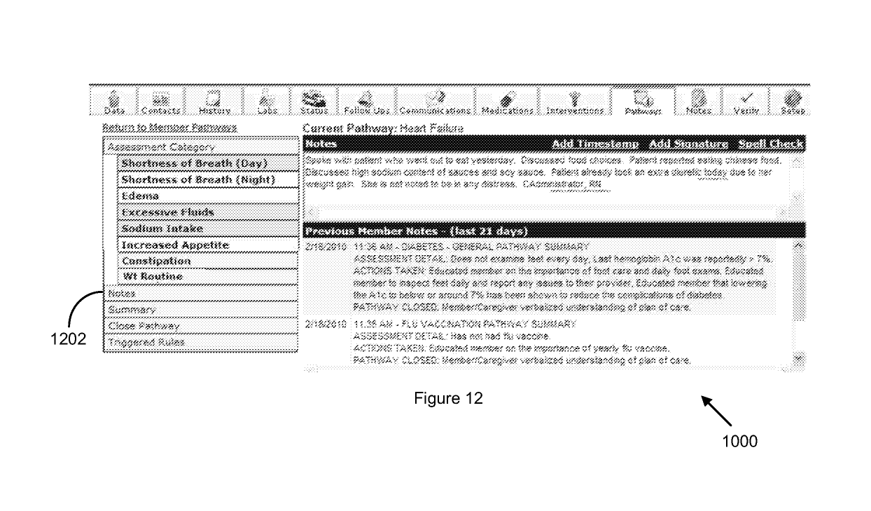

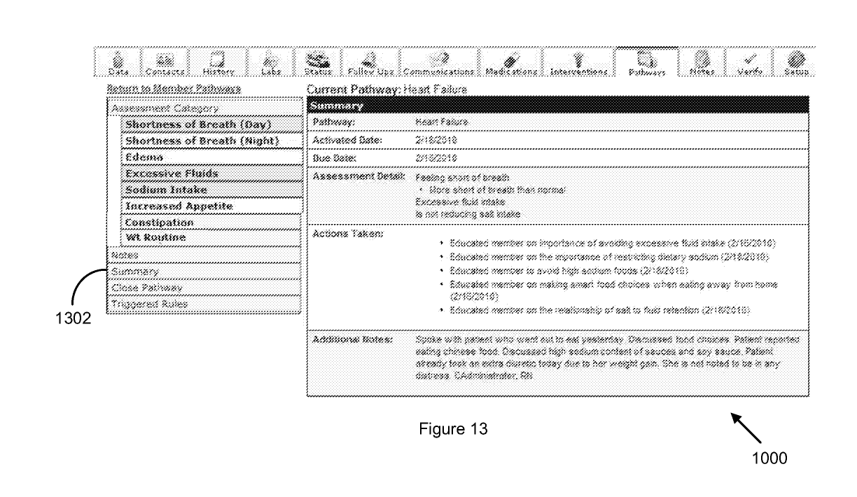

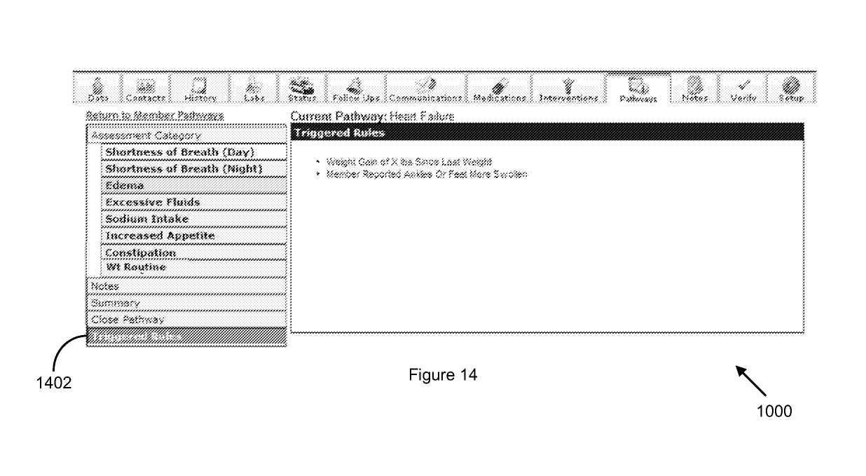

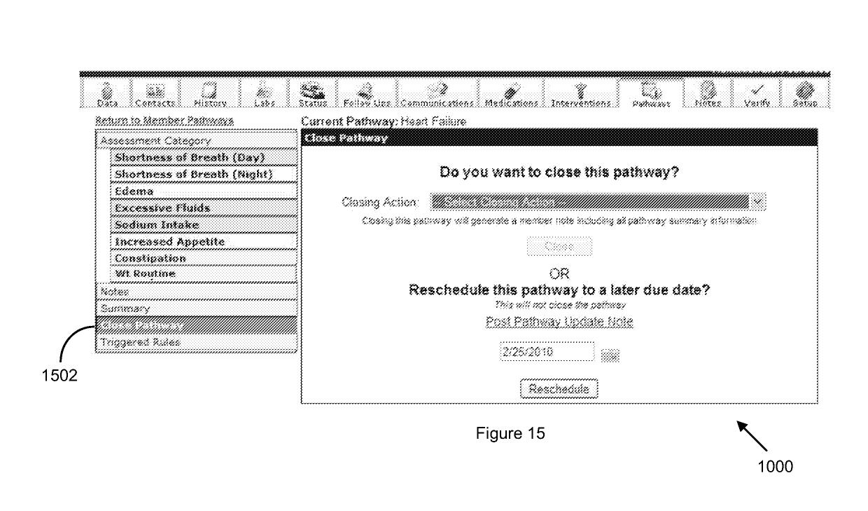

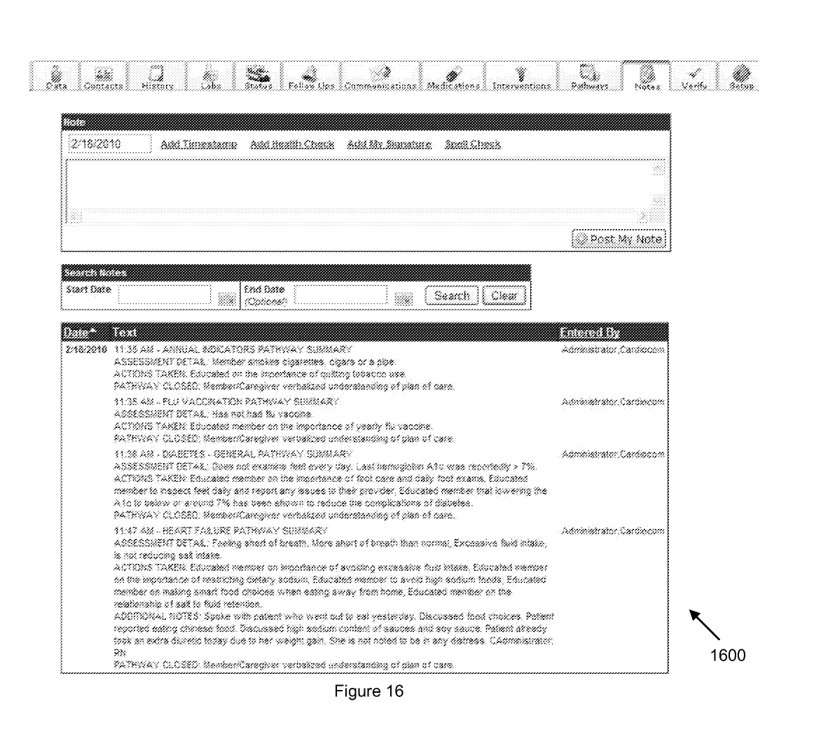

Referring to FIG. 12, each pathway 1000 has a Notes filed 1202 where a user can freelance notes and see previous notes. Referring to FIG. 13, each pathway 1000 has a “Summary” 1302 where a user can view a summary of the pathway. The summary is preferably dynamically built when the user selects questions and actions and documents standardized text notes. Referring to FIG. 14, each pathway 1000 has a “triggered rules” 1402 section where a user can view the rules that triggered the pathway. Referring to FIG. 15, each pathway 1000 has a “close pathway” 1502 section. A user can select a “closing action” and the “close” button will become enabled as long as all required documentation is completed in the pathway. A user can also reschedule the pathway with a new due date in the future. The pathway will stay open, but now be displayed in the “scheduled pathways” section in the member pathway work queue. Referring to FIG. 16, when a user closes a pathway, the system generates a “Pathway Summary” note 1600 that includes all of the details for that pathway.

Various embodiments provide one or more advantages. For instance, embodiments can be used to remotely monitor patients who are under treatment for HF, Hypertension, Diabetes, COPD, ESRD, CKD, and other complex chronic conditions. In some scenarios, remote monitoring with exception-based response can provide a lower-cost solution than frequent monitoring performed directly by a nurse or other health care professional. Furthermore, while the condition of a patient may change frequently, some embodiments provide a convenient and relatively inexpensive way to monitor a patient with any desired schedule. From the patient's perspective, use as directed of some embodiments may manage the patient's condition to minimize deterioration or hospitalization.

The weight measuring devices of the present invention can be used to monitor a patient that is known or suspected to have a disease or health-related condition known to be associated with weight change. The term “monitoring” as used herein refers to methods by which a healthcare provider can estimate or determine whether or not a patient with a disease or health-related condition requires a change in therapy based on the measure of a particular parameter (such as weight or blood pressure of the patient).

The terms “assessing” and “assessment” refer to methods by which a healthcare provider can monitor or determine the change in health status. The healthcare provider often makes a health status assessment on the basis of one or more vital sign or symptom status questions that is indicative of the change in the patients condition.

A “disease” or “health-related condition” can be any pathological condition of a body part, an organ, or a system resulting from any cause, such as infection, genetic defect, and/or environmental stress. The cause may or may not be known.

In some embodiments, the weight change may be a change that is associated with volume overload or volume depletion. Volume overload refers to expansion of the extracellular volume. Non-limiting examples of diseases and conditions associated with volume overload include renal failure, heart failure, cirrhosis of the liver, nephrotic syndrome, preeclampsia, and pregnancy. Non-limiting examples of diseases and conditions associated with volume depletion include inadequate fluid intake, hemodialysis, peritoneal dialysis, diarrhea, acute renal failure, diabetes, diuretic therapy, adrenal disorders, and acute gastroenteritis.

The patient may be known or suspected to have a kidney disease. “Kidney disease”, as used herein refers to an acute or chronic injury to at least one kidney of a subject, and in particular renal tubular cell injury. Kidney injury can be confirmed by any of a number of measurable criteria known in the art, including but not limited to measurement of the level of microalbuminuria and glomerular filtration rate (GFR). The kidney disease may be CKD.

ESRD almost always follows CKD. A person with CKD may have gradual worsening of kidney function for 10-20 years or more before progressing to ESRD. Non-limiting examples of causes of ESRD (and kidney disease) include chronic infection, chronic inflammation, glomerulonephritides, vascular disease, interstitial nephritis, a drug, a toxin, trauma, a renal stone, long standing hypertension, diabetes (diabetic nephropathy), heart failure, nephropathy from sickle cell anemia and other blood dyscrasias, nephropathy related to hepatitis, HIV, cystic kidney disease, congenital malformation, obstruction, malignancy, lupus nephritis, membranous glomerulonephritis, membranoproliferative glomerulonephritis, focal glomerular sclerosis, minimal change disease, cryoglobulinemia, Anti-Neutrophil Cytoplasmic Antibody (ANCA)-positive vasculitis, ANCA-negative vasculitis, amyloidosis, multiple myeloma, light chain deposition disease, complications of kidney transplant, chronic rejection of a kidney transplant, chronic allograft nephropathy, kidney disease of indeterminate cause, and the chronic effect of immunosuppressives.

ESRD patients may require renal replacement therapy (e.g., hemodialysis, peritoneal dialysis, or kidney transplantation), drug therapy, modification of fluid intake, and/or modification of diet.

The patient with ESRD may be afflicted with or was previously afflicted with a disease other than kidney disease. In particular, the other disease can be a disease linked to or predisposing one to kidney disease. For example, in some embodiments, the subject is a diabetic subject, as diabetes can be a risk factor for developing kidney disease. In some embodiments, the subject is a diabetic subject suffering from, or at risk of suffering from, diabetic nephropathy.

In the context of the present disclosure, “weight” refers to the measured heaviness of a patient to be monitored. Unless otherwise specified herein, weight can be measured using any method or device known to a patient, a healthcare provider, or to those of ordinary skill in the field of the invention. Weight can be determined and monitored by the healthcare provider at any frequency as determined by the patient's healthcare provider, taking into account the patient's disease and individual health status. For example, patient's weight can be measured once a day, twice a day, once every two days, once every three days, once a week, twice a week, once every two weeks, once every three weeks, or once a month using the devices and methods set forth herein.

A “weight parameter” as used herein refers to a specific value of a particular parameter that is determined or ascertained by a healthcare provider. In particular embodiments it is dependent upon the clinical course and/or characteristics of the particular patient that is to be monitored. Non-limiting examples of weight parameters include dry weight (as discussed above), weight of the patient immediately after a previous session of dialysis, weight of the patient immediately prior to a previous session of dialysis, weight of the patient within 1-2 weeks prior to or after a previous session of dialysis, weight of the patient within 2-3 weeks prior to or after a previous session of dialysis, or median weight of the patient between a first dialysis session and a subsequent dialysis session. A weight parameter may also be a median or mean weight of a subject of similar height from the same or a similar population of subjects.

Some embodiments of the present invention include comparing the weight of a subject to a first weight parameter and a second weight parameter. In these embodiments, the first weight parameter is distinct from the second weight parameter.

In some embodiments, generating information relevant to a patient's disease or health-related condition involves converting the weight of the patient to a Body Mass Index (BMI). BMI is calculated from the weight and height of the patient. The BMI of the patient may then be compared to at least one of the first and second parameters.

The healthcare provider will understand that associating a change in weight of a patient relative to one or more weight parameters may signal that a subject is more likely to suffer from an adverse event and that a particular instruction to the patient is warranted. The change in weight of the patient relative to a weight parameter that may warrant a change in therapy or patient instructions may vary and largely depends on the decision of the healthcare provider and individual characteristics of the patient.

In some embodiments of the present methods, multiple determination of patient weight can be made, and a temporal change in the weight relative to one or more weight parameters can be used to monitor the progression of disease and/or efficacy of appropriate therapies directed against the disease. For example, one might expect to see a decrease or an increase in weight over time during the course of effective therapy. Thus, in addition to monitoring patients, the presently disclosed subject matter provides in some embodiments a method for determining treatment efficacy and/or progression of ESRD in a subject.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method performed by a computerized central monitoring system for the assessment of a remotely monitored patient, the method comprising:
receiving data indicative of a physiological parameter;
scanning the data;
determining if any of the data matches pre-defined criteria, and if any of the data matches pre-defined criteria, then
generating a medical pathway for assessment by a user; and
providing output including the medical pathway;
wherein the user can follow the medical pathway to assess, educate, intervene, or treat the patient; or notify a remote health care provider of the patient status.

2. A method according to claim 1, wherein receiving data includes receiving data indicative of a weight of the patient.

3. A method according to claim 1, wherein receiving data includes receiving data indicative of the blood pressure of the patient.

4. A method according to claim 1, wherein receiving data includes receiving subjective health status or adherence to treatment plan responses of the patient.

5. A method according to claim 1, further comprising assigning the medical pathway to the patient.

6. A method according to claim 1, further comprising receiving input from the user in response to a portion of the medical pathway.

7. A method according to claim 6, further comprising generating a secondary medical pathway based on the input received from the user.

8. A method according to claim 7, wherein the secondary medical pathway is a pathway that adds additional detail to the first pathway.

9. A method according to claim 1, wherein the medical pathway prompts predefined assessment questions or action steps for the user to follow.

10. A method according to claim 1, wherein the user is a nurse.

11. A method according to claim 1, wherein the medical pathway includes guide me links for the user.

12. A method according to claim 1, wherein receiving data includes receiving data indicative of a physiological parameter, device data, and patient input data and further comprising creating an automated clinical note for the user that includes the physiological parameter, the device data, and the patient input data.

13. A method according to claim 12, wherein the automated clinical note further includes medical pathways data, predefined criteria data, action steps data and other ancillary data.

14. A method according to claim 13, wherein the automated note is automatically sent to the patient's physician based on predefined criteria.

15. A method according to claim 1, further comprising suspending or rescheduling the medical pathway to activate at a predetermined future date.

16. A method according to claim 1, wherein generating a medical pathway includes generating a medical pathway based on data from an external data repository that may contain lab data, quality indicators or other information applicable to the patient.

17. A method according to claim 1, wherein generating a medical pathway includes generating a medical pathway based on data from a patient's home hemodialysis machine.

18. A method according to claim 1, further comprising triggering a communication automatically by the medical pathway.

19. A method according to claim 18, wherein the communication is an outbound call, email, or text.

20. A method according to claim 19, wherein the communication is to the patient or the patient's designated health care professional.

21. A method according to claim 1, further comprising sending the data to a third computing device.

22. A method according to claim 21, wherein the third computing device is a dialysis center.

23. A computerized system for assessment of remotely monitored patients, the system comprising:
a receive module for receiving data from remote monitoring devices;
a pathways module for generating medical pathways based on the data received; and
a management module for managing a plurality of medical pathways.

24. The system of claim 23, wherein the management module prioritizes the plurality of medical pathways by order of importance.

25. The system of claim 24, wherein the pathways module assigns the medical pathway to a patient.

26. The system of claim 25, wherein the management module organizes medical pathways by patients.

27. The system of claim 26, wherein the management module includes sub-modules for assessment categories, notes, summary, and triggering rules.

28. The system of claim 23, wherein the management module allows a user to parse through the pathway to assess a patient.

29. The system of claim 28, wherein the management module allows additional pathway information to be generated based on input from the user.

30. The system of claim 23, wherein the management module provides links to guide or help a user.

31. The system of claim 30, wherein the management module generates alerts for overdue pathways.

32. A method performed by a computerized monitoring device for the assessment of a remotely monitored patient, the method comprising:
receiving data indicative of a physiological parameter;
scanning the data;
determining if any of the data matches pre-defined criteria, and if any of the data matches pre-defined criteria, then
generating a medical pathway relevant to End Stage Renal Disease (ESRD) for assessment by a user; and
providing output including the medical pathway;
wherein the user can follow the medical pathway to assess, diagnose, or treat the patient.

33. A method according to claim 32, wherein receiving data includes receiving data indicative of a weight of the patient.

34. A method according to claim 32, wherein receiving data includes receiving data indicative of a blood pressure of the patient.

35. A method according to claim 32, wherein receiving data includes receiving data indicative of subjective health status or adherence to treatment plan responses of the patient.

36. The method of claim 32, in which the output comprises an interactive message regarding establishing communication with a healthcare provider.

37. The method of claim 32, further comprising:
presenting one or more interactive messages to a patient, the one or more interactive message being relevant to ESRD;
receiving responses to the one or more interactive messages; and
communicating data about the responses to a health care provider over a network.

38. The method of claim 32, further comprising sending the data and the medical pathway to a dialysis center.
